(19) United States
(12) Patent Application Publication
(10) Pub. No.: US 2008/0167059 A1
(43) Pub. Date: Jul. 10, 2008

(54) Message composition method

(75) Inventor: Song Kyoo Kim, Daegu Metropolitan City (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/975,502

(22) Filed: Oct. 19, 2007

(30) Foreign Application Priority Data
Jan. 5, 2007 (KR) 2007-0001335

(51) Int. Cl. H04Q 7/20

(52) U.S. Cl. 455/466

(57) ABSTRACT

A message composition method for a mobile terminal is disclosed for facilitating composition of messages having different contents by selectively combining various types of data stored in the mobile terminal. The message composition method of the present invention includes presenting a set of raw data items representing data files in a unified data screen, generating at least one transmission data represented by a transmission data item composed by selecting and arranging at least one of the raw data items; and mapping the transmission data item to at least one recipient phone number.

### CLAIMS OF PRIORITY

This application claims the benefit of the earlier filing date, pursuant to 35 USC 119(a) to that patent application entitled “MESSAGE COMPOSITION METHOD” filed in the Korean Intellectual Property Office on Jan. 5, 2007 and assigned Serial No. 2007-0001335, the contents of which are incorporated herein by reference.

### BACKGROUND OF THE INVENTION

1. Field of the Invention

The present invention relates to message composition and, in particular, to a message composition method for composing message having different contents by selectively combining various types of data stored in a mobile terminal.

2. Description of the Related Art

With the advance of mobile and computing technologies, mobile phones are becoming very powerful and dominant device for mobile computing. Mobile phones are evolving into mobile multi-function terminals with the incorporation of various functions such as text messaging, audio, image, video, and gaming functions.

Text messaging, i.e. short message service (SMS), has achieved huge success in wireless communication field in addition to the fundamental voice communication.

Unlike a phone call, an SMS message can be sent to a recipient even when the recipient has not switched on the mobile phone or in a place where the wireless signal is temporarily unavailable.

The messaging service has been further developed in the form of Enhanced Messaging Service (EMS), and Multimedia Messaging Service (MMS) whereby various multimedia data, such as voice, music, image, and video, can be exchanged through the messaging service.

The messaging service supports multicast as well as unicast such that an identical message can be transmitted to more than two recipient terminals at the same time. Such mult-cast transmission is referred to as group messaging.

However, the conventional group messaging service is not appropriate for transmitting different messages to different recipients. In order to send multiple recipients different messages, it is required to compose massages with different contents and send the messages one by one to corresponding recipients. Such a process is time consuming and cumbersome.

### SUMMARY OF THE INVENTION

The present invention provides a message composition method for a mobile terminal that enables composing a message using information stored in the mobile terminal.

The present invention provides a message composition method for a mobile terminal that enables facilitating composition of multiple message having different contents for different recipients.

In an aspect of the present invention, a message composition method for a mobile terminal includes presenting a set of raw data items representing data files in a unified data screen, generating at least one transmission data represented by a transmission data item composed by selecting and arranging at least one of the raw data items; and mapping the transmission data item to at least one recipient phone number.

In accordance with another aspect of the present invention, a message composition method for a device having a display includes displaying a message composition screen on the display in response to a user command; activating a group transmission function, displaying a unified data window presenting a unified data generated by grouping a plurality of raw data items representing respective data stored in the device, generating at least one transmission data item by combining at least one of the raw data items and assigning at least one recipient phone number to each transmission data item.

### BRIEF DESCRIPTION OF THE DRAWINGS

The above features and advantages of the present invention will be more apparent from the following detailed description in conjunction with the accompanying drawings, in which:

FIG. 1 is a block diagram illustrating mobile terminal employing a message composition method according to an exemplary embodiment of the present invention;

FIG. 2 is an exemplary view illustrating the raw data stored in the storage unit of FIG. 1;

FIG. 3 is an exemplary view illustrating the unified data stored in the storage unit of FIG. 1;

FIG. 4 is an exemplary view illustrating a transmission data stored in the storage unit of FIG. 1;

FIG. 5 is a screen image illustrating a transmission data arrangement screen provided in a message composition method according to an exemplary embodiment of the present invention;

FIG. 6 is an exemplary view illustrating a transmission data composition procedure of a message composition method according to an exemplary embodiment of the present invention;

FIG. 7 is a flowchart illustrating a unified data generation procedure of a message composition method according to an exemplary embodiment of the present invention; and

FIG. 8 is a flowchart illustrating a message composition method according to an exemplary embodiment of the present invention.

### DETAILED DESCRIPTION OF THE INVENTION

Exemplary embodiments of the present invention are described with reference to the accompanying drawings. The same reference numbers are used throughout the drawings to refer to the same or like parts. Detailed descriptions of well-known functions and structures incorporated herein may be omitted to avoid obscuring the subject matter of the present invention.

The following definitions are provided to enable an understanding of the detailed description of the invention. Unless otherwise noted, terms are to be understood according conventional usage by those skilled in the relevant art. While the invention is shown and described with reference to certain exemplary embodiments thereof, it will be understood by those skilled in the art that various changes in form and details may be made therein without departing from the spirit and scope of the invention as defined by the appended claims.

Although the following describes aspects of the present invention in terms of a mobile handset, it should be clear that the following also applies to other electronic devices such as, for example, cellular phones, digital broadcast receivers, Personal Digital Assistant (PDA), Smart phones, Code Division Multiple Access (CDMA) terminal, Wideband CDMA (WCDMA) terminals, Global System for Mobile Communication (GSM) terminals, General Packet Radio System (GPRS) terminals, and similar handheld devices having a processor with memory containing firmware and/or application software.

In the following description, the message composition method of the present invention is described with a multimedia message service (MMS). However, the present invention can be applied to other message service such as text message service.

FIG. 1 is a block diagram illustrating mobile terminal employing a message composition method according to an exemplary embodiment of the present invention.

Referring to FIG. 1, the mobile terminal 100 includes a storage unit 120, a key input unit 130, a display unit 140, a Radio Frequency (RF) unit 150, and a control unit 160.

The storage unit 120 contains application programs for operating the message composition method and is configured to store raw data to be used for composing a message and unified data (U_data) and temporarily store transmit data (T_data). The storage unit 120 can be configured to have a program region and a data region for storing the application programs and data, respectively.

The program region stores an operating system (OS) and various application programs related to supplementary functions (such as camera function, sound play function, still and motion picture play functions) in addition to the messaging service-related application programs. The mobile terminal 100 activates the applications in response to user requests and executes specific functions of the applications under the control of the control unit 160.

The data region stores the various types of data including the messaging service-related data, i.e. raw data (Raw_data), unified data (U_data), and transmission data (T_data).

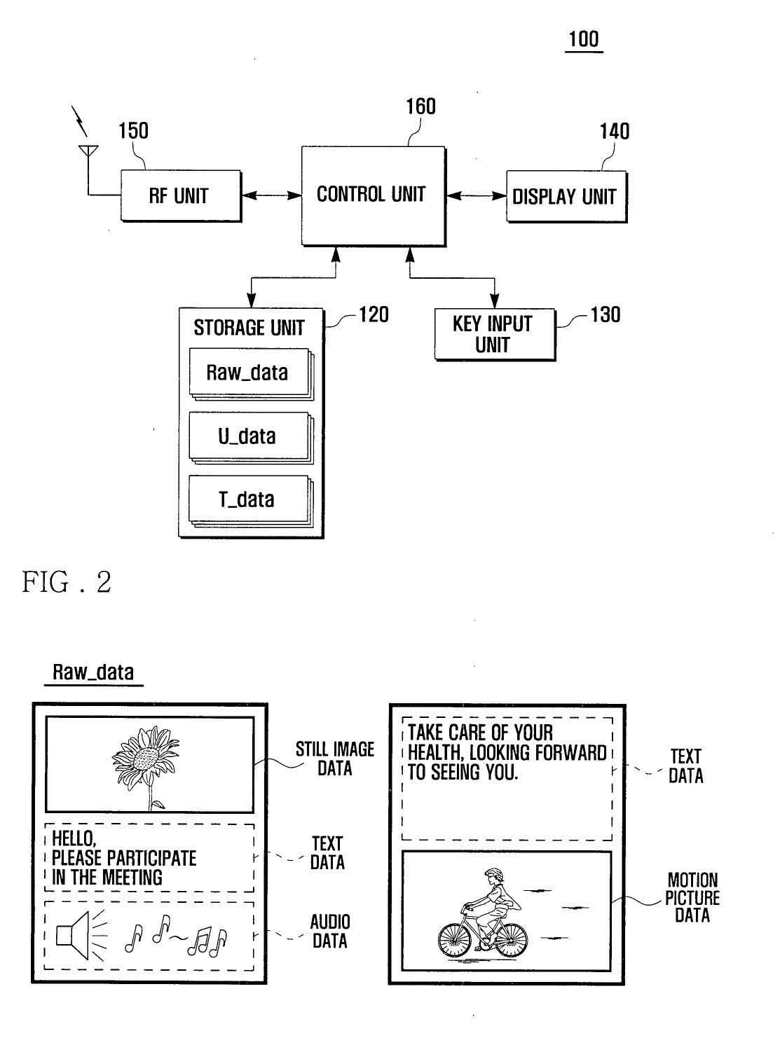

FIG. 2 is an exemplary view illustrating the raw data stored in the storage unit 120 of FIG. 1.

Referring to FIG. 2, the raw data includes multimedia data such as tests, audio and video files. Such data can be the ones stored in the manufacturing phase of the mobile terminal, and obtained by user input, during a multimedia communication, and using a file download function. In this embodiment, the raw data (R_data) includes text, still and motion image, and sound files. The text file can be generated by a user data input and downloaded from Internet. The still and motion image and sound files can be obtained using image capture functions in cooperation with supplementary multimedia functions of the mobile terminal and downloaded from other devices and through Internet. The still and motion images can be processed to produce a background image of a message, and the sounds also can be processed to produce a background music of a message.

The R_data also can exist in the combination of the text, audio, and image data.

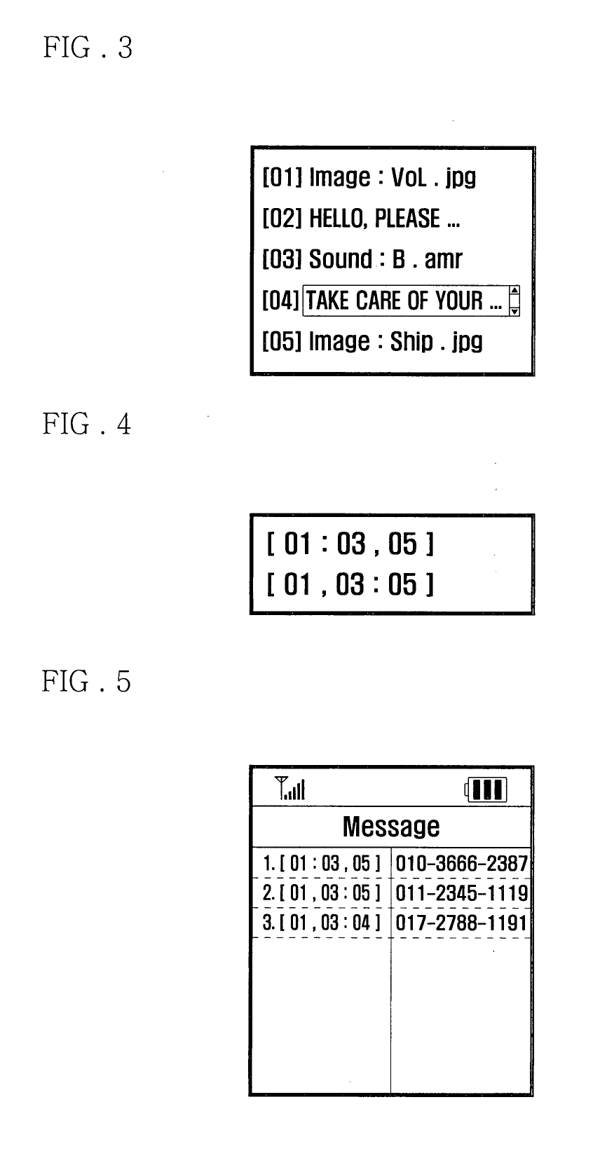

FIG. 3 is an exemplary view illustrating the unified data stored in the storage unit of FIG. 1.

The unified data (U_data) is a set of raw data generated by grouping the raw data selected by the user. The raw data belonged to a unified data can be selected for producing a transmission data (T_data). The unified data (U_data) is provided in the form of a list of raw data items assigned an index rather than any physical combination of the raw data themselves. The raw data items are linked to their corresponding raw data by means of the indexes such that, when a raw data belonged to the unified data (U_data) is selected for producing a transmission data (T_data), the selected raw data becomes a part of the transmission data (T_data). The transmission data (T_data) are produced by arranging the raw data indexes according to a transmission data composition grammar. The unified data (U_data) can be a message received from another mobile terminal. In this case, the text, audio and image data constituting the received message are assigned the raw data indexes. A unified data (U_data) screen supports a scroll function such that, when the length of the title of the selected raw data item is too long to be presented on the screen, the title slides in a direction or is presented in the form of a balloon text or a popup window.

In the case of a text data item, the unified data screen can be configured to present the text data item with the content of the text data rather than its title. Also, the content text can be presented in a slide manner or in the form of a balloon text or a popup window.

FIG. 4 is an exemplary view illustrating a transmission data stored in the storage unit of FIG. 1.

Referring to FIG. 4, the transmission data (T_data) is, produced by selectively arranging the raw data indexes listed in the unified data (U_data) in accordance with a grammar. That is, the transmission data (T_data) expresses a message to be actually transmitted by scripting the indexes representing the raw data (Raw_data) constituting the unified data (U_data) with symbols of which functions are defined in the transmission data script grammar.

The key input unit 130 includes a plurality of alphanumeric and function keys for generating sequences. The function keys include navigation keys and shortcut keys for executing specific functions of the mobile terminal. The sequences generated by the keys are transferred to the control unit 160.

The key input unit 130 is configured to generate commands for generating the unified data (U_data), selecting some or all of the raw data (Raw_data) belonged to the Unified data (U_data), generating the transmission data (T_data), receiving call numbers to which the transmission data (T_data) to be transmitted, transmitting the message represented by the transmission data (T_data). Such commands are transferred to the control unit 160.

The display unit 140 provides a unified data (U_data) composition screen for composing a unified data (U_data) and a transmission data (T_data) composition screen for composing a transmission data using the punctuation marks defined in the transmission data script grammar.

FIG. 5 is a screen image illustrating a transmission data arrangement screen provided in a message composition method according to an exemplary embodiment of the present invention.

Referring to FIG. 5, transmission data arrangement screen is provided with two sections: left for listing at least one transmission data (T_data) and right for phone numbers to which the respective transmission data (T_data) to be transmitted.

Although the transmission data arrangement screen provides a transmission data section and a phone number section in this embodiment, the present invention is not limited to the illustrated embodiment. That is, the number of the sections and arrangement of the sections can be modified, without altering the scope of the invention.

If a transmission data (T_data) is required to be added to the transmission data section of the transmission data arrangement screen, the unified data (U_data) is presented in the form of a popup window or in a unified data screen that lists the raw data items constituting the unified data (T_data).

The transmission data corresponding to the transmission data items listed in the transmission data section can be presented in the form of a preview window having preview sections for all of the transmission data or in the form a full screen window for each.

That is, the transmission data can be presented in a multi-window screen showing respective transmission data at the same, and each of the transmission data can be selectively presented in a full screen window.

The RF unit 150 is responsible for processing radio signals. Particularly, the radio signals carrying the raw data (Raw_data) and unified data (U_data) generated by a counterparty mobile terminal. The RF unit 150 transmits the transmission data to at least one recipient terminal under the control of the control unit 160. In order to exchange the transmission data (T_data), the RF unit 150 is provided with an RF transmitter for up-converting and amplifying transmission signals and an RF receiver for low-noise amplifying and down-converting the received signals.

The control unit 160 controls general operations of the mobile terminal and signaling between internal units of the mobile terminal. The control unit 160 can incorporate a modem and a codec.

Particularly, the control unit 160 controls the message composition-related functions in this embodiment. The control unit 160 generates a unified data (D_data) by processing a plurality of raw data (Raw_data) selected from the storage unit 120 in accordance with user command input through the key input unit 130. The control unit 160 displays a unified message composition screen in response to a key input and registers the raw data (Raw_data) selected in response to a key input for the unified data (U_data) and presented on the unified message composition screen in the form of a list. The control unit 160 assigns an index number to the selected raw data (Raw_data) together with a title of the raw data and presents as a raw data item on the unified data composition screen.

The control unit 160 also displays a message composition screen in response to a key input. The message composition screen can be integrated with the unified data composition screen such that the screen can be switched for composing the message and generating the unified data in accordance with a menu option. The control unit 160 also provides the grammar for composing the transmission data (T_data) with the items of the unified data (U_data).

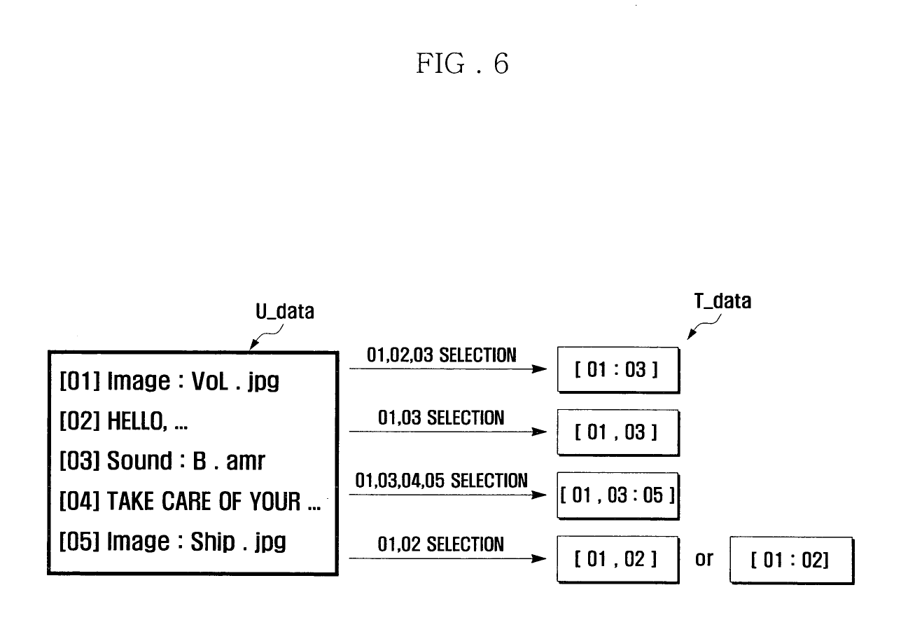

FIG. 6 is an exemplary view illustrating a transmission data composition procedure of a message composition method according to an exemplary embodiment of the present invention.

Referring to FIG. 6, five raw data items indexed from 01 to 05 are listed in the unified data screen. In order to compose a message including the contents of the first to third items, the transmission data (T_data) is scripted as [1:3]. That is, the punctuation mark ‘:’ is used to select a series of items such that the first item of the series is flowed by the colon and the last item of the series are following the colon.

In the meantime, the transmission data script [01,03] indicates that the transmission data is composed with the items indexed by 01 and 03. That is, the punctuation mark (comma) is used for arranging discontinuously numbered items. The function marks, colon and comma, can be used in the same transmission data script. For example, the transmission data script [01,03:05] indicates that the transmission data is composed with the items indexed by 01 and 03 to 05. In the meantime, the transmission data scripts [01,02] and [01:02] means the same transmission data (T_data).

Although the mobile terminal is schematically depicted only with the elements associated with the message composition function, the mobile terminal is not limited to the configuration of FIG. 1. For example, the mobile terminal can include at least one of an audio processing unit, a camera, and a digital broadcast receiver.

Operations of the above structured mobile terminal are described hereinafter in detail.

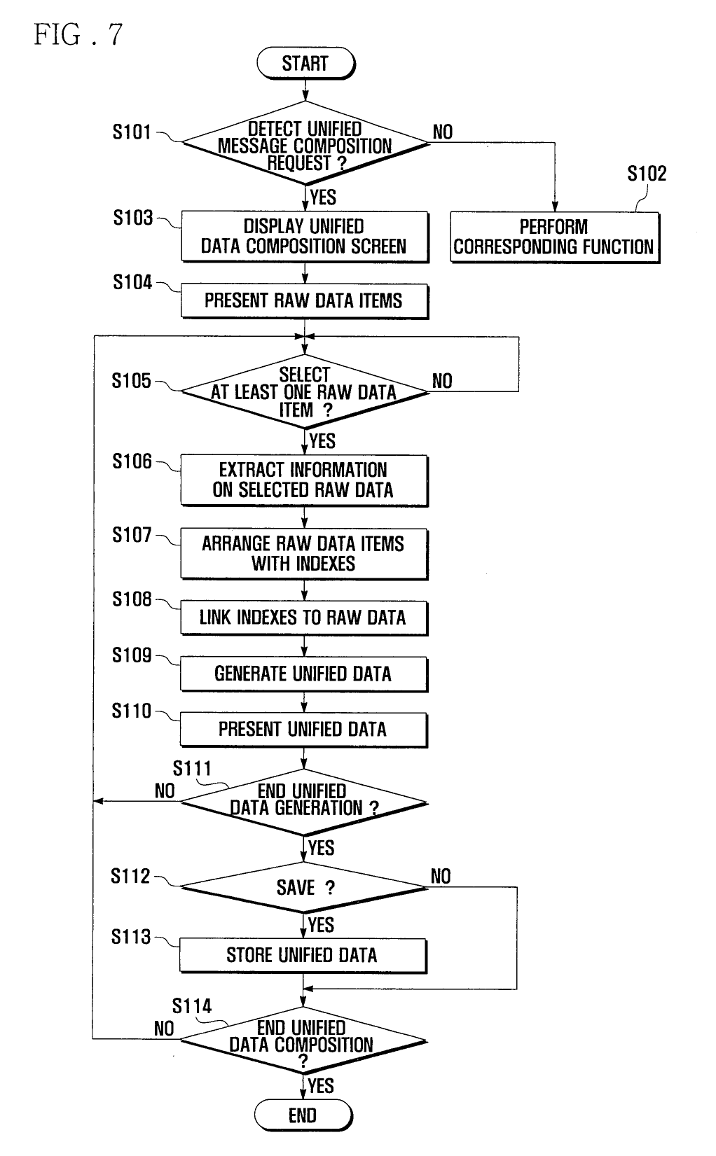

FIG. 7 is a flowchart illustrating a unified data generation procedure of a message composition method according to an exemplary embodiment of the present invention.

Referring to FIG. 7, in association with the message composition method of the present invention, the control unit 160 of the mobile terminal monitors the detection of a command input and determines whether the input command is a unified data composition request command (S101). If the detected input command is a unified data composition request command, the control unit 160 causes a unified data composition screen (S103) to be displayed and presents raw data items representing raw data (Raw_data) stored in the storage unit 120 (S104).

Next, the control unit 160 determines whether a selection command is input for selecting at least one raw data item from the raw data list (S105). The raw data (Raw_data) can be presented in a full screen view or multi window screen views in response to predetermined user commands under the control of the control unit 160.

If a selection command is input, the control unit 160 extracts the information on the selected raw data from the selection command (S106).

Here, the raw data (Raw_data) can be the text, audio, and video data. The control unit 160 classifies the raw data by type and arranges the classified raw data in an order. In the case that multiple raw data are selected, the raw data can be assigned by page number such that the raw data can be presented in a full screen view or a multi window screen view with reference to the page numbers. Also, the raw data items can be arranged in various manners with the page numbers.

After extracting the information on the selected raw data, the control unit 160 assigns indexes to the raw data items so as to arrange the raw data items with the indexes (S107).

For example, assuming that the first raw data includes a still image “Vol.jpg” a text “Hello, please participate in the meeting”, and an audio data “B.amr”, and the second raw data includes text data “Take care of your health, looking forward to seeing you” and a motion picture “Ship.3gp”, the raw data are dissembled by type, such that raw data items “Vol.jpg”, “Hello, please participate in the meeting”, “B.amr”, “Take care of you health, looking forward to seeing you” are assigned respective indexes.

Next, the control unit 160 links the indexes to the corresponding raw data stored in the storage unit (S108) and generates a unified data (U_data) incorporating the raw data (S109). Next, the control unit 109 presents the unified data on the unified data screen in the form of an indexed raw data list (S110).

The indexed raw data items listed on the unified data screen are linked to respective physical data stored in the storage unit such that each physical data can be presented in response to a user request.

After a unified data are generated, the mobile terminal determines whether a unified data generation end command is detected (S111). If a unified data generation end command is detected, the control unit 160 determines whether a unified data-save command is detected (S112). If a unified data-save command is detected, the control unit 160 stores the unified data (S113).

If a unified data generation end command is not detected at step S111, the control unit 160 repeats steps S105 such that another raw data can be added to the unified data (U_data). That is, the control unit 160 allows the user to add new raw data to the unified data or delete some or all of the raw data constituting the unified data while presenting the unified data.

After storing the unified data at step S113, the control unit 160 determines whether a unified data composition procedure end command (S114) is received. If a unified data composition procedure end command is detected, the control unit 160 ends the unified data generation procedure, and otherwise, repeats step S105.

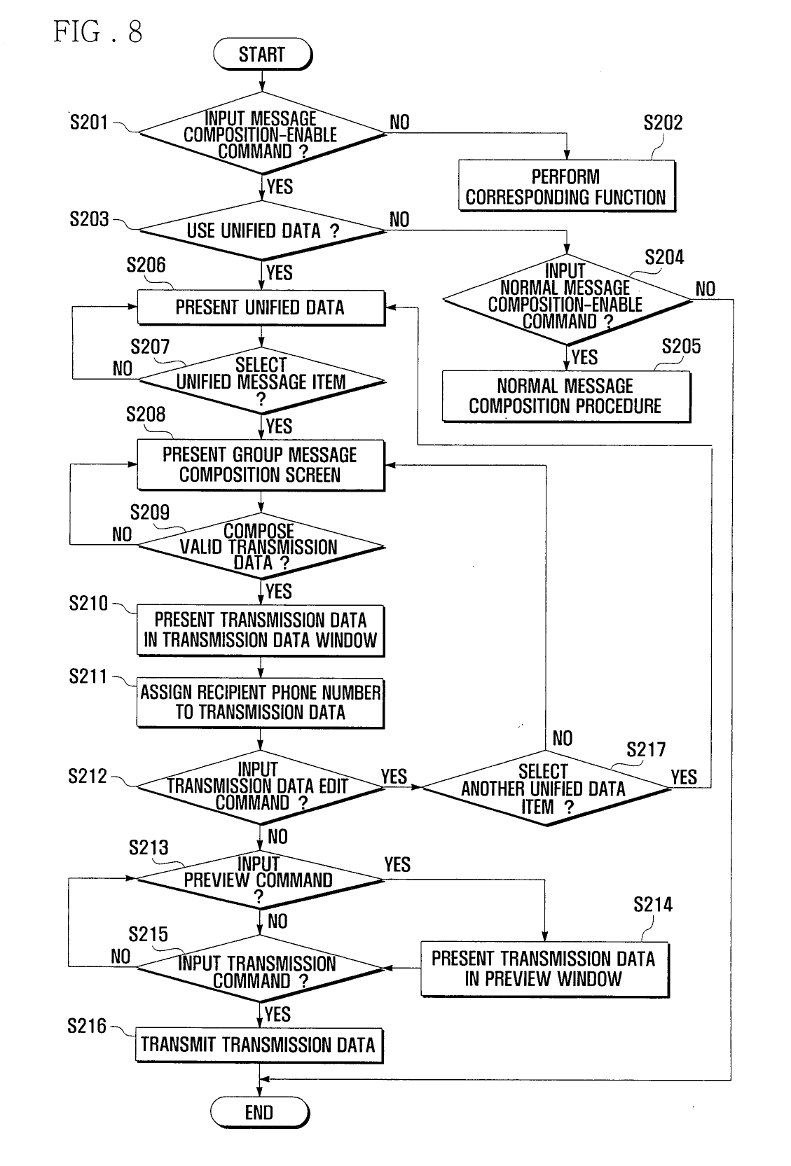

FIG. 8 is a flowchart illustrating a message composition method according to an exemplary embodiment of the present invention.

Referring to FIG. 8, the control unit 160 monitors a command input and determines, if a command is detected, and whether the command is a message composition-enable command (S201). If the command input is not the message composition-enable command, the control unit 160 performs an operation corresponding to the command (S202). If the command input is the message composition-enable command, the control unit 160 displays a message composition screen.

The control unit 160 then determines whether a unified data-enable command is input (S203).

At step S203, the control unit 160 further presents an option selection guide message in the form of a popup window or a dialog box such that the unified data-enable command is generated by selecting a unified data-based message composition option provided on the popup window or the dialog box.

If a unified data-enable command is not input, the control unit 160 determines whether a normal message composition-enable command is input (S204). If a normal message composition-enable command is input, the control unit 160 enters a normal message composition mode. In the normal message composition mode, a normal message composition screen is presented such that the user can compose a message using alphanumeric and special characters and decorate the message with at least one of audio and video files manually selected from the storage unit.

If a unified data-enable command is input, the control unit 160 presents a unified data (U_data) listing at least one unified data item (S206) and determines whether an item selection command is input (S207). In a case that the unified data (U_data) includes too many unified data items to show in a window, the unified data items can be scrolled using navigation buttons.

If an item selection command is input, the control unit 160 presents a group message composition screen (S208). The group message composition screen includes horizontally split windows to show a transmission data window and a phone number window. Each transmission data listed in the transmission data window is mapped to at least one of phone numbers listed to the phone number window.

While the group message composition screen is presented, the control unit 160 determines whether a transmission data (T_data) is composed with valid punctuation marks defined in the transmission data script grammar (S209). If a transmission data (T_data) is composed with valid punctuation marks, the control unit 160 presents the transmission data (T_data) in the transmission data window (S210) and assigns at least one recipient phone number to the transmission data in the phone number window in response to user key input (S211).

Next, the control unit 160 determines whether a transmission data edit command is input (S212). If a transmission data edit command is not input, the control unit 160 determines whether a preview command is input (S213). If a preview command is input, the control unit 160 presents the transmission data in a preview window (S214).

The preview function operates in such a manner that one of the transmission data listed in the transmission data window of the message composition screen is highlighted by a cursor and the content of highlighted transmission data is presented in the form of a preview window. The control unit 160 also can present all of the transmission data in the preview mode at the same time. The transmission data (T_data) are assigned an index such that the transmission data is selected by its index to be presented in the preview mode.

If a preview command is not input or a confirmation key is t input in preview window, the control unit 160 determines whether a transmission command is input (S215). If a transmission command is input, the control unit 160 causes the transmission data (T_data) to be transmitted to respective recipient terminals (S216).

At step S212, if the transmission data edit command is input, the control unit 160 determines whether an item selection command is input for selecting another unified data item (S217).

The transmission data edit command can be represented by the input of the punctuation mark. That is, if a valid punctuation mark is input while composing a transmission data, the control unit determines that a transmission data edit command is input.

Step S217 can be selected as an option so as to be skipped in accordance with a user configuration.

At step S217, if a transmission data edit command is input, the control unit 160 repeats step S206. Otherwise, the control unit 160 repeats step S208

In this embodiment, the message composition method generates a unified data (U_data) listing various types of raw data and enables composing a message by combining the raw data selected from the unified data (U_data), whereby multiple message can be quickly generated with different content.

Although the unified data (U_data) includes all the types of data such as text, audio, and video data in the above exemplary embodiment, each unified data (U_data) can be composed of only one type of data, i.e. text data, audio data, or video data.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A message composition method for a mobile terminal, comprising:
presenting a set of raw data items representing data files in a unified data screen;
generating at least one transmission data represented by a transmission data item composed by selecting and arranging at least one of the raw data items; and
mapping the transmission data item to at least one recipient phone number.

2. The message composition method of claim 1, further comprising presenting the transmission data in a preview window.

3. The message composition method of claim 2, wherein the preview window is a multi section window having a plurality sections for presenting multiple transmission data at the same time or a full screen window for presenting a single transmission data.

4. The message composition method of claim 1, further comprising generating a unified data which is the set of raw data items, comprising:
presenting a unified data composition window;
loading at least one combined data composed of at least one raw data;
selecting at least one combined data;
extracting the raw data constituting the combined data;
arranging the extracted raw data in an order; and
linking the extracted raw data to the corresponding data files.

5. The message composition method of claim 4, further comprising:
presenting the unified data; and
storing the unified data together with a title which is input by a key manipulation or automatically assigned.

6. The message composition method of claim 1, wherein the transmission data is composed with punctuation marks defined in a transmission data script grammar.

7. The message composition method of claim 1, further comprising transmitting the transmission data to the recipient phone number.

8. The message composition method of claim 7, further comprising presenting another set of raw data items.

9. The message composition method of claim 1, wherein the data files is selected from the group of: text, audio, and video data files.

10. The message composition method of claim 9, wherein the text data file is presented as a single row text.

11. The message composition method of claim 10, wherein the single row text has a length to be presented on a screen at a time.

12. The message composition method of claim 11, wherein the text data file is presented in a window the form of which is selected from the group consisting of: a scroll window, popup window, text balloon, and sliding ticker.

13. The message composition method of claim 9, wherein the text, audio, and video data files are linked to corresponding raw data items presented in the unified data screen.

14. The message composition method of claim 9, wherein the raw data items are presented with titles of the data files.

15. A message composition method for a device having a display, comprising:
displaying a message composition screen on the display in response to a user command;
activating a group transmission function;
displaying a unified data window presenting a unified data generated by grouping a plurality of raw data items representing respective data stored in the device;
generating at least one transmission data item by combining at least one of the raw data items; and
assigning at least one recipient phone number to each transmission data item.

16. The message composition method of claim 15, further comprising selectively presenting contents of the transmission data items in a preview window.

17. The message composition method of claim 15, wherein the preview window comprises a plurality of preview sections for presenting contents of the transmission data items.

18. The message composition method of claim 15, wherein the data is selected from the group of: text, audio, and video data.

19. The message composition method of claim 18, wherein the text data being partially presented in a single row text, and entire text of the text data being presented in the form of a scroll window, popup window, balloon text, or sliding ticker by selecting the text data item.

20. The message composition method of claim 18, wherein the raw data items constituting the unified data are linked to the respective text, audio, and video data item is presented with title of the corresponding data.
